(19) United States
(12) Patent Application Publication
(10) Pub. No.: US 2013/0107282 A1
(43) Pub. Date: May 2, 2013

(54) IMAGE FORMING APPARATUS

(71) Applicant: Joon-hee KIM, Suwon-si (KR)

(72) Inventor: Joon-hee KIM, Suwon-si (KR)

(73) Assignee: Samsung Electronics Co., Ltd., Suwon-si (KR)

(21) Appl. No.: 13/540,942

(22) Filed: Jul. 3, 2012

(30) Foreign Application Priority Data
Nov. 1, 2011 (KR) 10-2011-0112986

(51) Int. Cl. G06K 15/02

(52) U.S. Cl. 358/1.1

(57) ABSTRACT

An image forming apparatus includes: a main body; image forming cartridges detachably disposed in the main body and each including; an image carrier unit having an image carrier; a developing unit that is configured to swing with respect to the image carrier unit and has a developing roller; and an elastic member configured to bring the developing roller into contact with the image carrier; a cover to open or close a portion of the main body; a contact-separating unit that is disposed in the main body and is configured to selectively separate the developing roller and the image carrier of each of the image forming cartridges; and a connecting unit that causes the contact-separating unit to operate according to operation of the cover.

### CROSS-REFERENCE TO RELATED APPLICATIONS

This application claims the benefit under 35 U.S.C. §119(a) from Korean Patent Application No. 2011-0112986 filed Nov. 1, 2011, in the Korean Intellectual Property Office, the disclosure of which is incorporated herein by reference in its entirety.

### BACKGROUND OF THE INVENTION

1. Field of the Invention

The present disclosure relates to an image forming apparatus. More particularly, the present disclosure relates to a contact type developing apparatus that is used in an electro photographic image forming apparatus.

2. Description of the Related Art

In general, an electro-photographic image forming apparatus, such as a laser printer, a facsimile machine, a copy machine, or the like, is a printing apparatus which forms an electrostatic latent image on an image carrier, develops the electrostatic latent image with a developer, and transfers a developer image onto a printing medium to perform a printing operation.

A developing apparatus that is used in the image forming apparatus includes an image carrier on which an electrostatic latent image is formed by an exposure unit, and a developing member that supplies a developer to the image carrier and develops the electrostatic latent image as a developer image. A method of developing the electrostatic latent image on the image carrier using the developing member may be classified as a contact type method in which the developing member comes in contact with the image carrier and a non-contact type method in which the developing member does not come in contact with the image carrier.

The non-contact type developing method may exhibit large changes in image quality due to a thickness dimension of a spacing member that maintains a gap between the developing member and the image carrier, an outer diameter and a runout dimension of the developing member, and environment factors such as temperature, humidity, etc. To minimize image quality variations, the parts of the apparatus should have precise dimensions and voltages should be precisely controlled according to the environment conditions. However, compared to the non-contact type developing method, the contact type developing method is stable with respect to the environment changes and is less dependent on the dimension precision of the parts. Therefore, in recent years, the contact type developing method has become widely used.

However, in the contact type developing method, since the image carrier and the developing member are rotated while in contact with each other, the image carrier and the developing member experience significant wear and tear. Accordingly, reducing the hardness of the developing member can extend the life of the image carrier and the developing member. Due to the above-described problems, the contact type developing method uses a developing member having a lower hardness.

If prolonged contact occurs between the developing member having a lower hardness and the image carrier, quality problems such as compression set, migration, etc., occur in the developing member. The compression set occurs when a contacting portion of the developing member, which is pressed by the image carrier for a long period of time, is not restored to its original state. The migration refers to when substances contained in the developing member come out of the developing member and become adhered to the image carrier due to heat and pressure generated by prolonged contact between the developing member and the image carrier. If the above-described phenomena occur, horizontal stripes may be formed on a printed image during a rotation cycle of the developing member or during the outer circumferential surface cycle of the image carrier, thereby resulting in poor image quality. To prevent such issues, the developing member and the image carrier should be kept apart while the image forming apparatus is being distributed after manufacture.

A special spacing member is generally used to maintain the separation of the developing member from the image carrier during distribution. Further, a developing apparatus is generally packaged separately from a main body of the image forming apparatus for distribution purposes. In this case, a user is required to remove the special spacing member from the developing apparatus and then mount the developing apparatus into the main body of the image forming apparatus, before using the image forming apparatus.

Alternatively, after the developing member and the image carrier are separated from each other by a spacing member disposed in a developing apparatus, the developing apparatus is packaged separately from the main body of the image forming apparatus and is then distributed. After that, when a user mounts the developing apparatus into the image forming apparatus, the spacing member is automatically moved so that the developing member and the image carrier come into contact with each other.

However, in the methods of separating the developing member as described above, since the developing apparatus and the image forming apparatus are separately packaged, the package volume thereof is increased. Therefore, distribution costs are also increased.

Accordingly, there is a need for providing an image forming apparatus having a developing apparatus configured such that the developing apparatus can be mounted inside the main body of the image forming apparatus during distribution while the developing member and the image carrier remain out of contact and away from each other. In addition, when a user uses the image forming apparatus after distribution, the developing member and the image carrier should be able to be brought into contact with each other without a special operation on the part of the user before printing is performed.

### SUMMARY OF THE INVENTION

The present disclosure overcomes the above drawbacks and other problems associated with the conventional arrangement. The present inventive concept provides an image forming apparatus having a developing apparatus configured such that a developing member and an image carrier can be mounted inside a main body of the image forming apparatus in a state separated from each other and can be distributed in that state, and the developing member and the image carrier can come in contact with each other without a user's manipulation to perform a printing operation.

Additional features and utilities of the present general inventive concept will be set forth in part in the description which follows and, in part, will be obvious from the description, or may be learned by practice of the general inventive concept.

The above and/or other features of the present disclosure can substantially be achieved by providing an image forming apparatus that includes: a main body; image forming cartridges detachably disposed in the main body, each of the image forming cartridges comprising; an image carrier unit comprising an image carrier; a developing unit that is disposed to swing at a predetermined amount with respect to the image carrier unit and that comprises a developing roller; and an elastic member that biases the developing roller toward the image carrier; a cover disposed to open or close a portion of the main body; a contact-separating unit that is disposed in the main body and selectively separates the developing rollers and the image carriers; and a connecting unit that transfers movements of the cover to the contact-separating unit. When the cover is opened the contact-separating unit separates the developing rollers and the image carriers, and when the cover is closed the elastic members bring the developing rollers into contact with the image carriers.

The image forming apparatus may include a control unit that controls the contact-separating unit according to a print command so that the contact-separating unit separates the developing roller and the image carrier of selected ones of the image forming cartridges.

The connecting unit may include: a link configured to slide along a side wall of the main body and that is connected to the cover; and levers that are rotatably disposed on the main body and transfer movements of the link to the contact-separating unit.

The contact-separating unit may include: force applying members to selectively contact the developing units; and a first supporting member to move the force applying members between a first position and a second position.

In the first position, the force applying members do not contact the developing units, and in the second position, the force applying members contact corresponding ones of the developing units to separate the developing rollers from the image carriers.

When the cover is opened each force applying member is disposed in the first position, and when the cover is closed, each force applying member is disposed in the second position.

The contact-separating unit may include fixing members disposed on the first supporting member, each fixing member configured to fix a corresponding one of the image carrier units when a corresponding one of the force applying members is located at the second position.

The contact-separating unit may include: force applying members to selectively contact the developing units; a first supporting member connected to the connecting unit and configured to move each of the force applying members between a first position and a second position; and a second supporting member to move each of the force applying members between the second position and a third position.

When in the first position, the force applying members do not contact the developing units. When in the second position, the force applying members contact the developing units to separate the developing rollers and the image carriers. When in the third position, the force applying members do not contact developing units so that the developing rollers contact the image carriers.

When the cover is opened, the force applying members may be located at the first position, and when the cover is closed, the force applying members may be located at the second position.

The contact-separating unit may include fixing members disposed on the first supporting member and configured to contact the image carrier units when the force applying members are located at the second position or the third position.

The image forming apparatus may include a control unit to control the contact-separating unit to separate selected ones of the developing rollers and the image carriers, according to a print command. The image forming cartridges comprise a first, a second, a third, and a fourth image forming cartridges, and during a preparation mode, the developing rollers of the first, second, third, and fourth image forming cartridges are separated from the corresponding image carriers.

When in a color printing mode, the control unit may control the contact-separating unit so that the developing rollers of the first, second, third, and fourth image forming cartridges contact the corresponding image carriers.

When in a mono printing mode, the control unit may control the contact-separating unit so that the developing rollers of the first, second, and third image forming cartridges are separated from the corresponding image carriers, and the developing roller of the fourth image forming cartridge contacts the corresponding image carrier.

The contact-separating unit may include: a bracket disposed in the main body and configured to slidably support the first and second supporting members; a third supporting member configured to slide with respect to the second supporting member; and a separation cam disposed between the second and third supporting members and configured to move the second and third supporting members. The force applying members may comprise first, second, and third force applying members that move up and down on the second supporting member and correspond to the first, second, and third image forming cartridges. The force applying members may also comprise a fourth force applying member that is configured to move up and down on the third supporting member and that corresponds to the fourth image forming cartridge.

The separation cam may include: a first cam portion to push the second and third supporting members; a second cam portion to push the second supporting member; and a third cam portion that does not push the second and third supporting member.

The second supporting member may include a first cam groove that is formed on a surface of the second supporting member facing the third supporting member. The third supporting member comprises a second cam groove that is formed on a surface of the third supporting member that faces the second supporting member. The separation cam is disposed in a cam space formed by the first and second cam grooves.

The second supporting member may include first and second cam contacting portions that are formed in the first cam groove and are configured to selectively contact the separation cam. The third supporting member may include third and fourth cam contacting portions that are formed in the second cam groove and are configured to selectively contact the separation cam.

When the separation cam pushes the second and third supporting members in a first direction, the first, second, third, and fourth force applying members may move from the second position to the third position. When the separation cam pushes the third supporting member in the first direction, the first, second, and third force applying members may remain in the second position, and the fourth force applying member may move from the second position to the third position.

A pressed portion may be formed on a top surface of the developing unit of each of the plurality of image forming cartridges and may receive a force from the contact-separating unit.

The above and/or other features of the present disclosure can also substantially be achieved by providing an image forming apparatus comprising: a main body; image forming cartridges detachably disposed in the main body, each of the image forming cartridges comprising: an image carrier; a developing roller; and an elastic member to bias the developing roller towards the image carrier; and a contact-separating unit disposed in the main body and configured to separate the developing roller and the image carrier of selected ones of the image forming cartridges, the image forming cartridges being selected according to a mode of the image forming apparatus.

The contact-separating unit may comprise: force applying members to selectively contact the developing units; and fixing members biased against the developing units; and the image forming apparatus further comprises a controller to control the contact separating unit to selectively extend the force applying members to separate the image carrier and developing roller of any of the developing units that are not operated during a current operating mode of the image forming apparatus.

The contact-separating unit may further comprise a cam member to selectively extend the force applying members.

Other features and utilities of the present disclosure will become apparent from the following detailed description, which, taken in conjunction with the annexed drawings, discloses preferred embodiments.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a sectional view schematically illustrating an image forming apparatus according to an exemplary embodiment of the present disclosure;

FIG. 2 is a sectional view illustrating the image forming apparatus in FIG. 1 when a cover thereof is open;

FIG. 3 is a side view illustrating a state that a contact-separating unit presses a plurality of image forming cartridges in the image forming apparatus of FIG. 1;

FIG. 4 is a side view illustrating an image forming cartridge used in an image forming apparatus according to an exemplary embodiment of the present disclosure, when a developing roller thereof is in contact with an image carrier thereof;

FIG. 5 is a sectional view illustrating the image forming cartridge of FIG. 4;

FIG. 6 is a side view illustrating an image forming cartridge used in an image forming apparatus according to an exemplary embodiment of the present disclosure, when a developing roller thereof is spaced apart from an image carrier thereof;

FIG. 7 is a sectional view illustrating the image forming cartridge of FIG. 6;

FIG. 8 is a sectional view illustrating a state that the contact-separating unit separates components of image forming cartridges of the image forming apparatus of FIG. 1;

FIG. 9 is a view illustrating a force applying member disposed in a first position when the cover of the image forming apparatus is closed as illustrated in FIG. 1;

FIG. 10 is a view illustrating the force applying member disposed in a second position when the cover of the image forming apparatus is open as illustrated in FIG. 2;

FIG. 11 is a perspective view illustrating the contact-separating unit of the image forming apparatus in FIG. 1;

FIG. 12 is an exploded perspective view illustrating the contact-separating unit of FIG. 11;

FIG. 13 is a perspective view illustrating the contact-separating unit of FIG. 11 from which a bracket is removed;

FIG. 14 is a perspective view illustrating the contact-separating unit of FIG. 13 from which a first supporting member is removed;

FIG. 15 is a perspective view illustrating a second supporting member of the contact-separating unit in FIG. 14;

FIG. 16 is a perspective view illustrating a third supporting member of the contact-separating unit in FIG. 14;

FIG. 17 is a perspective view illustrating a separation cam of the contact-separating unit in FIG. 12;

FIG. 18 is a side view illustrating a color printing mode of an image forming apparatus, according to an embodiment of the present disclosure, wherein a force applying member is moved from a second position to a third position by a contact-separating unit;

FIG. 19 (a) is a view illustrating a relationship between a separation cam and the second and third supporting members of the contact-separating unit, when the force applying member is at the second position in FIG. 18;

FIG. 19 (b) is a view illustrating relationship between the separation cam and the second and third supporting members when the force applying member is at the third position in FIG. 18;

FIG. 20 is a side view illustrating a mono printing mode of an image forming apparatus, according to an embodiment of the present disclosure, wherein a fourth force applying member is moved from a second position to a third position by the contact-separating unit;

FIG. 21 (a) is a view illustrating relationship between a separation cam of the contact-separating unit and the second and third supporting members when the force applying member is at the second position in FIG. 20; and

FIG. 21 (b) is a view illustrating relationship between a separation cam of the contact-separating unit and the second and third supporting members when the fourth force applying member is at the second position in FIG. 20.

Throughout the drawings, like reference numerals will be understood to refer to like parts, components, and structures.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

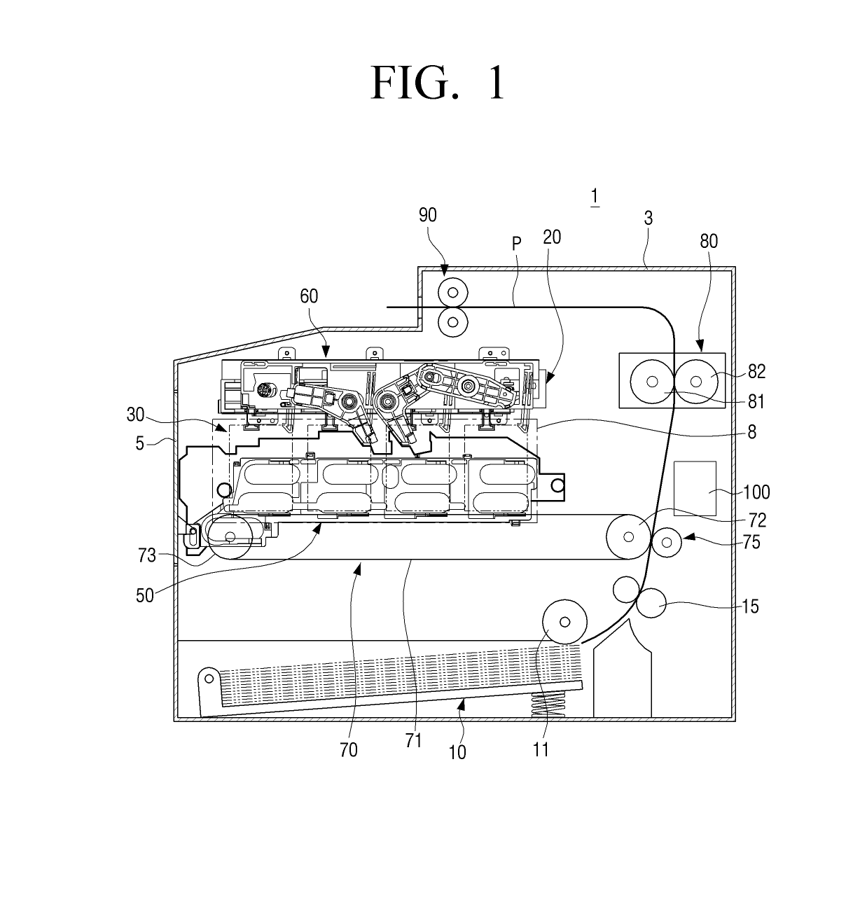

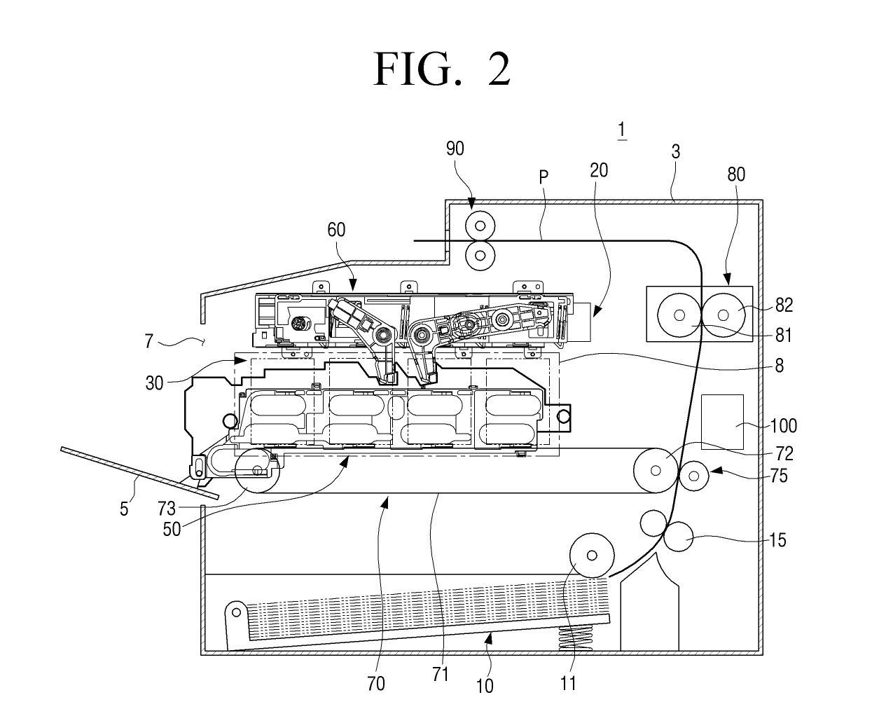

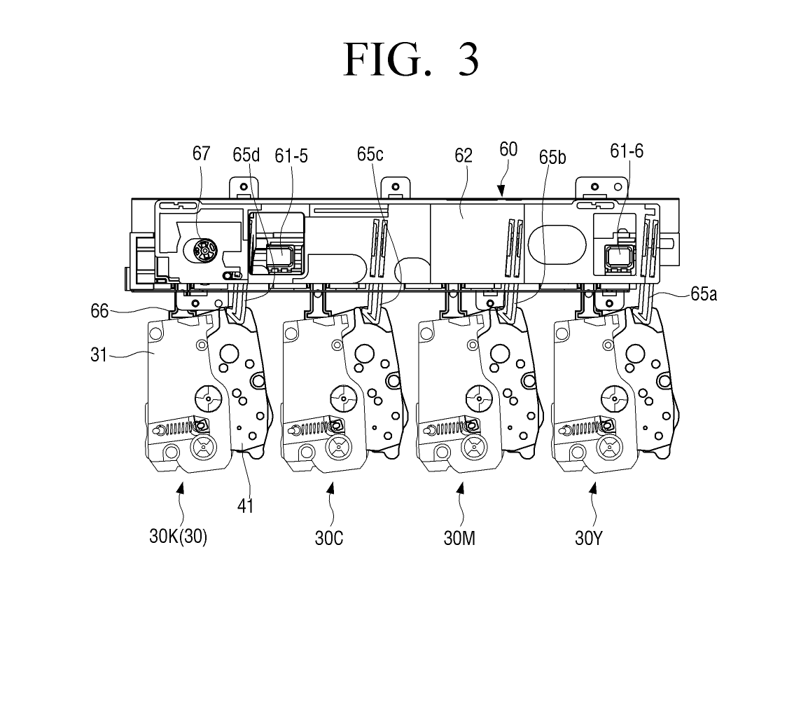

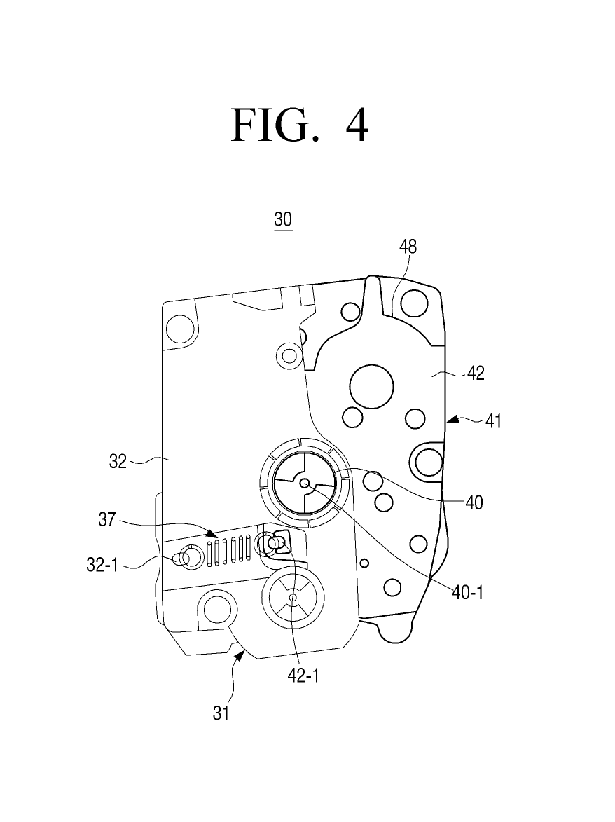

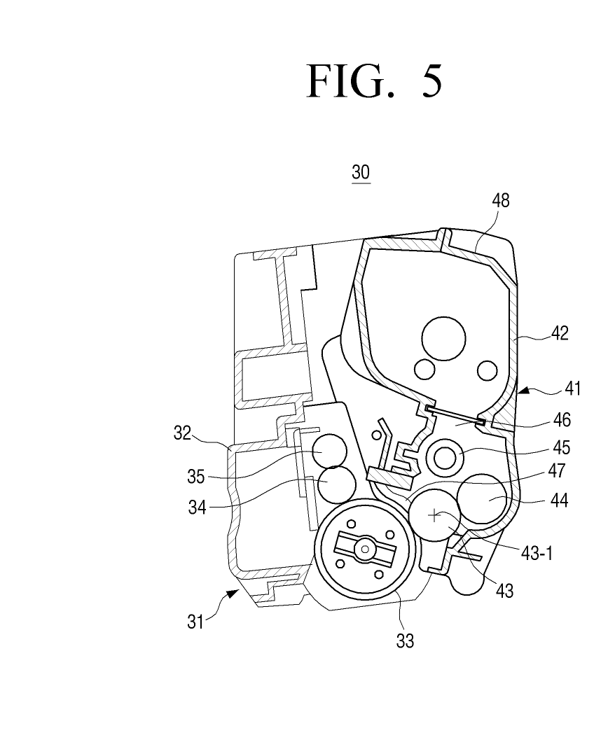

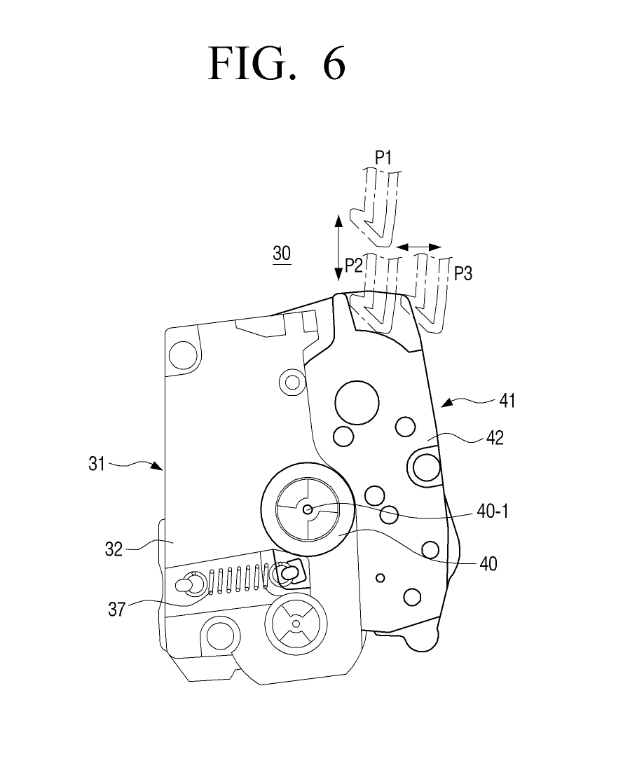

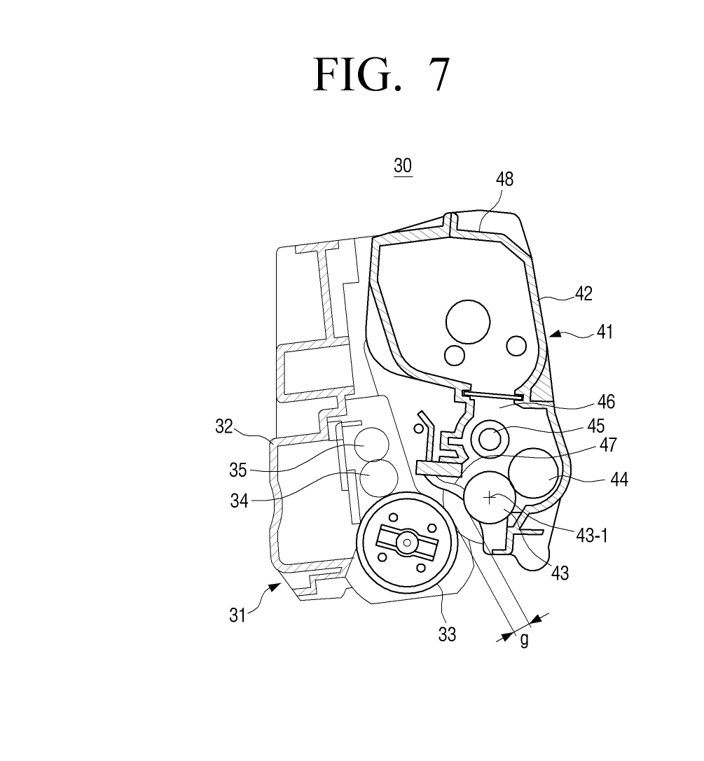

FIG. 1 is a sectional view schematically illustrating an image forming apparatus according to an embodiment of the present disclosure, and FIG. 2 is a sectional view illustrating the image forming apparatus in FIG. 1 when a cover thereof is open. FIG. 3 is a side view illustrating a state that a contact-separating unit presses against a plurality of image forming cartridges in the image forming apparatus of FIG. 1. FIGS. 4 and 5 are a side view and a sectional view illustrating an image forming cartridge used in an image forming apparatus according to an embodiment of the present disclosure when a developing roller thereof comes in contact with an image carrier thereof. FIGS. 6 and 7 are a side view and a sectional view illustrating an image forming cartridge used in an image forming apparatus according to an embodiment of the present disclosure when a developing roller thereof is spaced apart from an image carrier thereof.

Referring to FIGS. 1 to 7, an image forming apparatus according to an exemplary embodiment of the present disclosure includes a main body 3, a feeder unit 10, an exposure unit 20, a plurality of image forming cartridges 30, a connecting unit 50, a contact-separating unit 60, a transfer belt unit 70, a transfer roller 75, a fusing unit 80, a discharging roller 90, and a control unit 100.

The main body 3 forms an outer appearance of the image forming apparatus 1. The feeder unit 10, the exposure unit 20, the plurality of image forming cartridges 30, the connecting unit 50, the contact-separating unit 60, the transfer belt unit 70, the transfer roller 75, the fusing unit 80, the discharging roller 90, and the control unit 100 are disposed inside the main body 3. A cover 5 that opens or closes a portion of the main body 3 is disposed on a side-surface of the main body 3 to allow access to the inside of the main body 3.

The feeder unit 10 accommodates a predetermined number of sheets of printing media, and includes a pickup roller 11 that picks up and supplies the printing media sheet by sheet. In front of the pickup roller 11, in a direction in which the picked printing medium P is transported (downstream direction), a transport roller 15 is installed to transport the picked printing media P to the transfer roller 75.

The exposure unit 20 forms an electrostatic latent image on the image carriers 33 of the image forming cartridges 30 through the emission of light that corresponds to the received print data.

The image forming cartridges 30 form developer images that correspond to the print data. The image forming cartridges 30 may include a first image forming cartridge 30Y, a second image forming cartridge 30M, a third image forming cartridge 30C, and a fourth image forming cartridge 30K. Here, the first to fourth image forming cartridges 30Y, 30M, 30C, and 30K can form yellow, magenta, cyan, and black developer images, respectively.

The four image forming cartridges 30Y, 30M, 30C, and 30K may be disposed in a cartridge mounting box 8. When the cover 5 is opened as shown in FIG. 2, the cartridge mounting box 8 can be pulled out of the main body 3 through an opening 7 formed on a side surface of the main body 3. When the cartridge mounting box 8 is exposed outside of the main body 3, the four image forming cartridges 30Y, 30M, 30C, and 30K can be mounted into or separated from the cartridge mounting box 8. When the cartridge mounting box 8 is inserted into the main body 3, the cartridge mounting box 8 moves along a guide rail (not illustrated) disposed in the main body 3 and then is fixed at a predetermined position.

Alternatively, after the cover 5 is opened, the four image forming cartridges 30Y, 30M, 30C, and 30K may each be configured to be directly mounted into and/or separated from the main body 3 of the image forming apparatus 1. In this case, the image forming cartridge 30 may be configured to be mounted within or separated from the main body 3 in the lengthwise direction of the image forming cartridge 30 at a side surface opposite to a side surface of the main body 3 on which the contact-separating unit 60 is disposed.

As shown in FIG. 3, each of the image forming cartridges 30Y, 30M, 30C, and 30K includes an image carrier unit 31 and a developing unit 41 which can swing at a predetermined angle. Since the four image forming cartridges 30Y, 30M, 30C, and 30K have the same or similar structures, the first image forming cartridge 30Y for forming a yellow image will be hereinafter described as an example. The reference numeral of the image forming cartridge will be designated as “30” unless discrimination is necessary.

FIGS. 4 to 7 illustrate side views and sectional views of the image forming cartridge 30. Referring to FIGS. 4 to 7, the image carrier unit 31 may include an image carrier 33 and a charging body 34 that charges the image carrier 33. An electrostatic latent image is formed on the surface of the image carrier 33 by the light emitted from the exposure unit 20. A photosensitive drum may be used as the image carrier 33, and a charge roller may be used as the charging body 34. The image carrier unit 31 includes a first housing 32 that can rotatably support the image carrier 33 and the charging body 34. A coupler (not illustrated) which receives a power from an image carrier driving source (not illustrated) installed in the main body 3 may be installed on one side of the first housing 32. Accordingly, the image carrier 33 can receive the power from the image carrier driving source to rotate. Also, inside the first housing 32, a charging body cleaning member 35 that cleans the surface of the charging body 34 may be installed.

The developing unit 41 is installed to swing at predetermined angle (along an arc) around a hinge 40 with respect to the image carrier unit 31, and may include a developing roller 43, a developer supply roller 44, an agitator 45, and a regulating member 47. The developing unit 41 rotatably supports the developing roller 43, the developer supply roller 44, and the agitator 45. The developing unit 41 may include a second housing 42 in which a developer space 46 to store a developer is formed. The second housing 42 is formed to swing at a predetermined angle on the hinge 40 with respect to the first housing 32. A rotation center 43-1 of the developing roller 43 is spaced apart from a rotation center 40-1 of the hinge 40 so that the developing roller 43 can be separated from or come in contact with the image carrier 33 according to movements of the second housing 42. On one side of the second housing 42, a developing coupler (not illustrated) that receives a driving power from the developing driving source (not illustrated) installed in the main body 3 may be installed. The developing coupler may be disposed coaxially with the hinge 40.

A pressed portion 48 is formed on a top surface of the second housing 42 of the developing unit 41. The pressed portion 48 can selectively contact a force applying member 65 of the contact-separating unit 60.

An elastic member 37 is disposed on the side surfaces of the first housing 32 and the second housing 42. The elastic member 37 extends from a hooking part 32-1 of the first housing 32 and a hooking part 42-1 of the second housing 42. The elastic member 37 and the developing roller 43 are disposed on the same side of the hinge 40 that is a swing center of the second housing 42. The elastic member 37 biases the second housing 42 so that the second housing 42 rotates in the clockwise direction around the hinge 40. Accordingly, the developing roller 43 installed in the second housing 42 is located in a first position, in which the developing roller 43 comes in contact with the image carrier 33 installed in the first housing 32, due to a bias of the elastic member 37. A tension coil spring may be used as the elastic member 37. FIG. 4 illustrates the elastic member 37 installed on one side surface of the image forming cartridge 30. However, the same or similar elastic member 37 is also installed on the opposite side surface of the image forming cartridge 30, but is not illustrated in FIG. 4.

If the image forming cartridge 30 is mounted in the main body 3, the image carrier 33 and the developing roller 43 of the image forming cartridge 30 may receive the power from the driving sources disposed in the main body 3 and may be independently driven. When the image forming cartridge 30 is mounted in the main body 3, the image carrier unit 31 having the image carrier 33 is restricted to a fixed position. However, the developing unit 31 having the developing roller 43 can swing at a predetermined angle around the hinge 40, as illustrated in FIGS. 6 and 7.

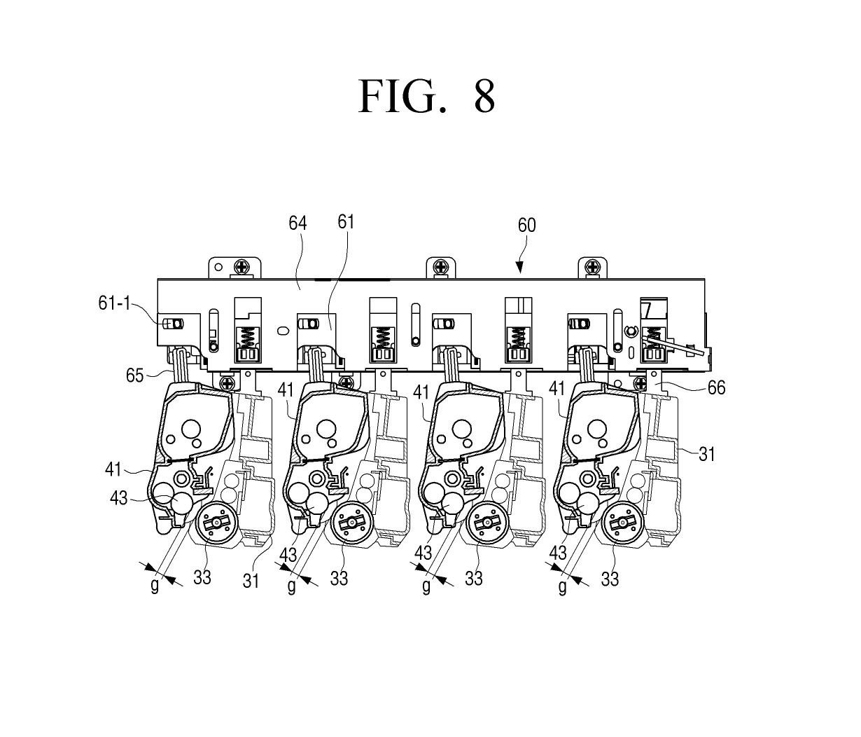

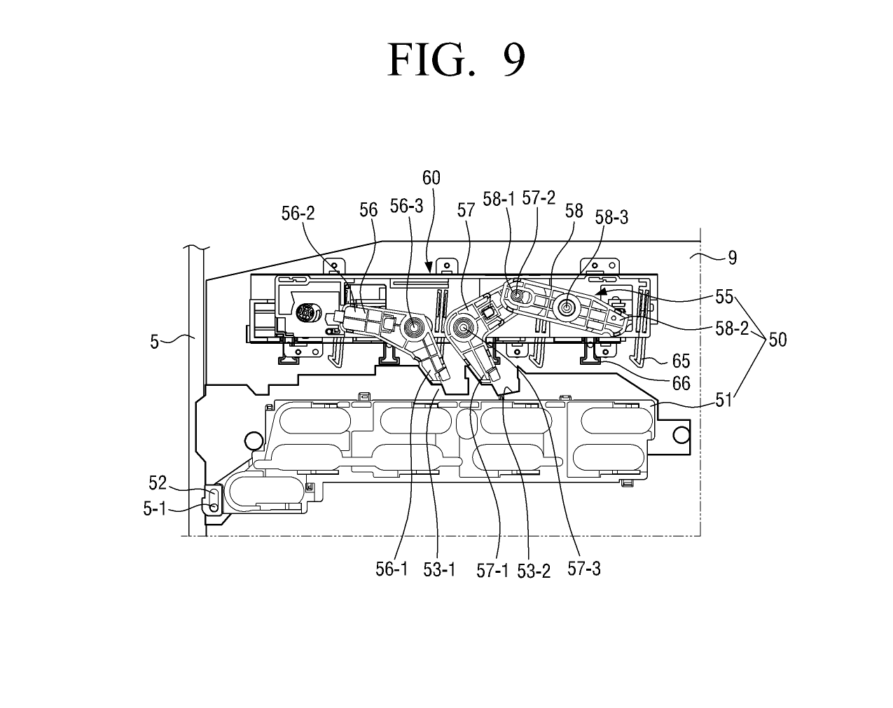

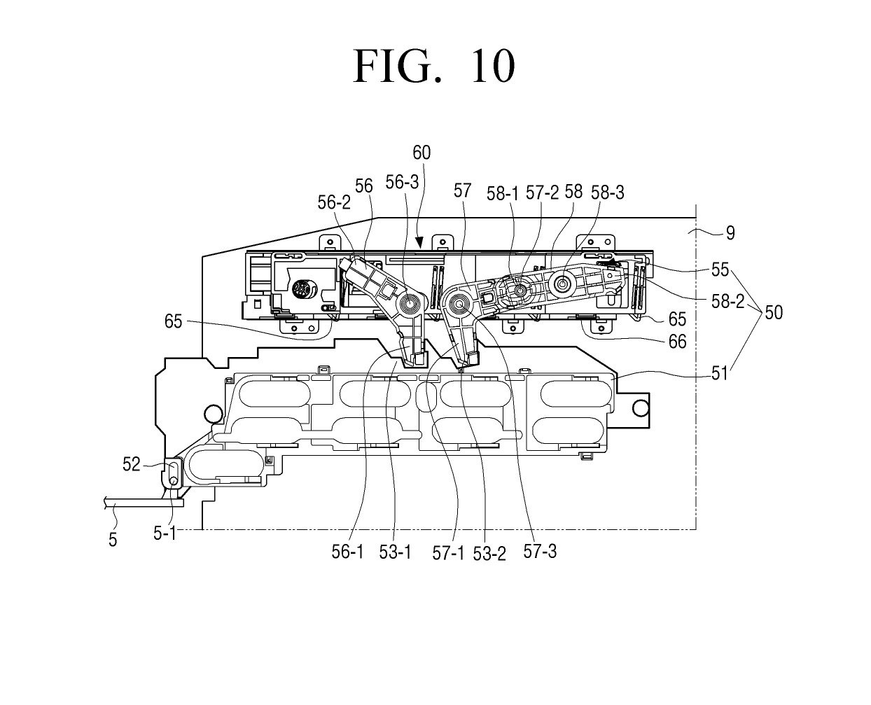

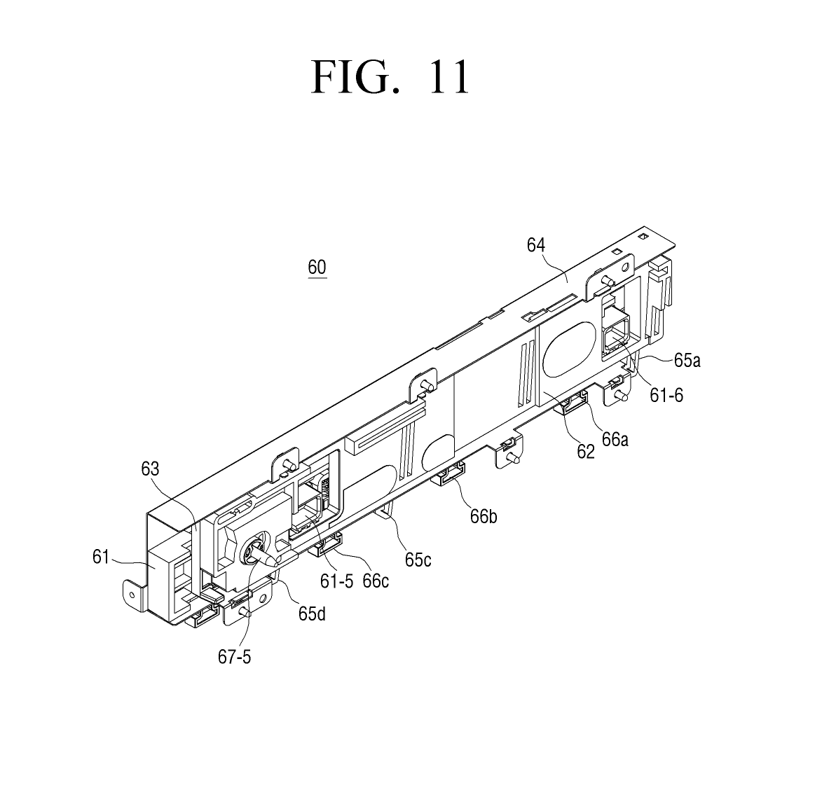

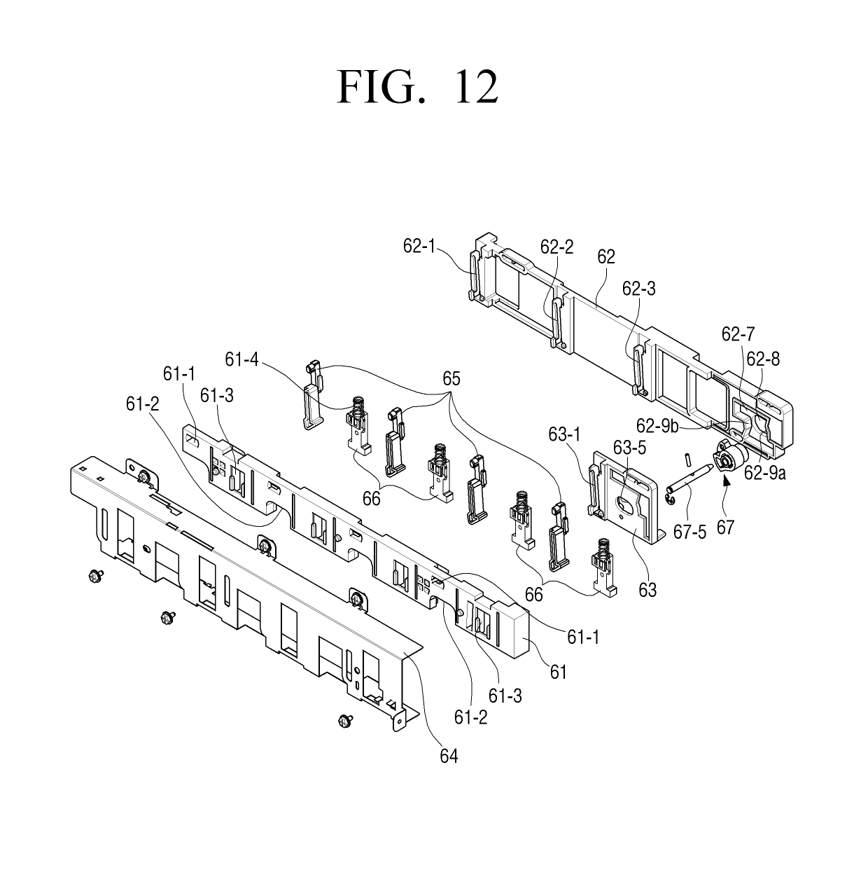

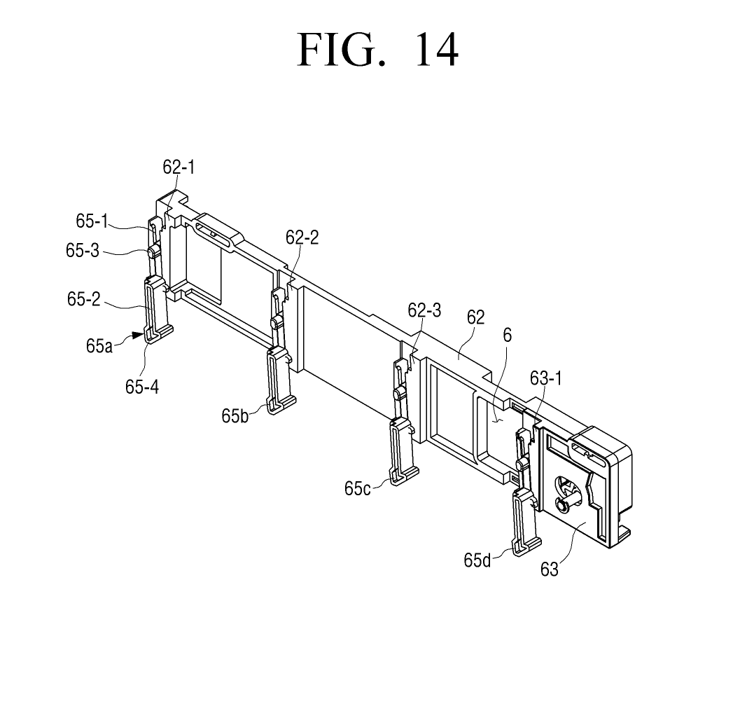

FIG. 8 illustrates image forming cartridges 30 disposed in the contact separation unit 60. FIGS. 9 and 10 illustrate the operation of the connecting unit 50 when the door 5 is open and when the door 5 is closed, respectively. FIGS. 11-17 illustrate perspective and exploded views of the contact-separating unit 60 and components thereof. Referring to FIGS. 1, 2, 8, 9, and 10, the connecting unit 50 connects the cover 5 and the contact-separating unit 60. The connecting unit 50 allows the contact-separating unit 60 to operate in association with the operation of the cover 5. The connecting unit 50 may include a link 51 and a plurality of levers 55.

The link 51 is disposed on a side wall of the main body 3 so as to slide toward the opening 7 in a direction parallel to the transfer belt unit 70. A connecting hole 52, which is connected to the cover 5, is formed at an end of the link 51 which is adjacent to the cover 5. The cover 5 includes a connecting pin 5-1 that is inserted in the connecting hole 52 to connect the cover 5 with the connecting hole 52. Accordingly, when the cover 5 rotates in a counterclockwise direction to open the opening 7, the connecting pin 5-1 contacts the connecting hole 52 to move the link 51 toward the opening 7.

The link 51 includes grooves 53-1 and 53-2 formed on an upper surface thereof that interact with the levers 55. The levers 55 are rotatably disposed on the side wall of the main body 3 and transmit motions of the link 51 to a first supporting member 61 of the contact-separating unit 60. Ends of the levers 55 contact the link 51 and other ends thereof are connected to the first supporting member 61. In this embodiment, the levers 55 include a first lever 56, a second lever 57 and a third lever 58. However, the present disclosure is not limited to any particular number of levers 55, as any suitable number of levers may be used.

Referring to FIGS. 9-17, the first lever 56 is connected to a front portion of the first supporting member 61. The third lever 58 is connected to a rear portion of the first supporting member 61. The first lever is disposed on the side wall of the main body 3 and is rotatable around a first rotation shaft 56-3. A first end 56-1 of the first lever 56 is connected with the first groove 53-1 of the link 51, and a second end 56-2 thereof contacts a first connecting groove 61-5 of the first supporting member 61 of the contact-separating unit 60. The second lever 57 is disposed on the side wall of the main body 3 and is rotatable around a second rotation shaft 57-3. A first end 57-1 of the second lever 57 contacts the second groove 53-2 of the link 51, and a second end 56-2 thereof is connected with the third lever 58. The second lever 57 operates as an intermediate lever that transmits the movement of the link 51 to the third lever 58. The third lever 58 is disposed on the side wall of the main body 3 and is rotatable around a third rotation shaft 58-3. A first end 58-1 of the third lever 58 is connected with the second end 57-2 of the second lever 57, and a second end 58-2 thereof is connected with a second connecting groove 61-6 of the first supporting member 61 of the contact-separating unit 60.

The link 51 reciprocates linearly with respect to the opening 7 (in a horizontal direction) according to the action of the cover 5. When the link 51 reciprocates, the first supporting member 61 reciprocates linearly (in a vertical direction) due to the action of the first, second, and third levers 56, 57 and 58. When the first supporting member 61 reciprocates, the force applying members 65 of the contact-separating unit 60 reciprocate between a first position and a second position. When the force applying members 65 are in the first position, the force applying members 65 do not apply a force to the developing unit 41 of each image forming cartridge 30. As such, the developing rollers 43 contact the image carriers 33. However, when the force applying members 65 are in the second position, the force applying members 65 apply force to the developing unit 41. As a result, as illustrated in FIG. 7, each developing roller 43 rotates a predetermined amount around the hinge 40, so that the developing roller 43 is spaced apart from the image carrier 33 by a distance g.

In accordance with the opening and closing action of the cover 5, a preparation mode, a color printing mode, and/or a mono printing mode, the contact-separating unit 60 individually presses the developing units 41 of the image forming cartridges 30 so that the developing rollers 43 of the developing units 41 come in contact with or are separated from the image carriers 33 of the image carrier units 31.

The contact-separating unit 60 may include a bracket 64, the first supporting member 61, a second supporting member 62, a third supporting member 63, the plurality of force applying members 65a-d, and a plurality of fixing members 66a-d (see, for example, FIG. 11). Hereinafter, is an example explanation of how the contact-separating unit 60 causes the developing roller 43 of each of four image forming cartridges 30Y, 30M, 30C, and 30K to come in contact with or be separated from the image carriers 33 thereof. Accordingly, the contact-separating unit 60 includes four force applying members 65a-d and four fixing members 66a-d, to correspond to the four image forming cartridges 30Y, 30M, 30C, and 30K.

The bracket 64 is formed to fix the contact-separating unit 60 to the main body 3 of the image forming apparatus 1. The bracket 64 may be disposed on a middle wall 9 of the main body 3, which is spaced apart from the side wall of the main body 3, to secure operation ranges of the link 51 and the levers 56, 57, and 58. The bracket 64 is formed to support the movements of the second supporting member 62.

The first supporting member 61 is disposed inside the bracket 64 and contacts the bracket 64. The first supporting member 61 moveably supports the force applying members 65 and the fixing members 66, which are configured to move up and down. The first supporting member 61 moves up and down with respect to the bracket 64 and the second supporting member 62. The first supporting member 61 includes four force applying member connecting portions, each of which including a top connecting hole 61-1 and a bottom moving groove 61-2 to accommodate a corresponding one of the force applying members 65. The connecting portions permit the force applying members to move in the lengthwise direction of the first supporting member 61. The first supporting member 61 also includes four fixing member installing portions 61-3 that hold the four fixing members 66.

The top connecting holes 61-1 are each formed as an elongated hole, so that a top projection 65-3 of the force applying member 65 inserted therein and can move in the lengthwise direction of the first supporting member 61. The bottom moving grooves 61-2 are each concave so that the lower portions 65-2 of the force applying members 65 inserted therein and can move in the lengthwise direction of the first supporting member 61. The fixing member installing portions 61-3 are each formed so that the fixing member 66 can move up and down but cannot move in the lengthwise direction of the first supporting member 61.

A pressure spring 61-4 is disposed between each of the fixing member installing portions 61-3 and the fixing member 66. When no force is applied to the lower end of the fixing member 66, the lower end of the fixing member 66 may be positioned at the substantially same level as that of the lower end of the force applying member 65.

Referring to FIG. 11 in particular, a first connecting groove 61-5, in which a connecting projection of the first end 56-1 of the first lever 56 is inserted, is formed on a front surface of the first supporting member 61, which faces the second supporting member 62. A second connecting groove 61-6, in which a connecting projection of the second end 58-2 of the third lever 58 is inserted, is also formed in the front surface of the first supporting member 61. The first connecting groove 61-5 is spaced apart at a predetermined distance from the second connecting groove 61-6. In this embodiment, the first connecting groove 61-5 is formed between the fourth force applying member 65d and the third fixing member 66c, and the second connecting groove 61-6 is formed between the first force applying member 65a and the first fixing member 66a. Therefore, the first supporting member 61 can be moved up and down with respect to the bracket 64 by the first, second, and third levers 56, 57, and 58 of the connecting unit 50.

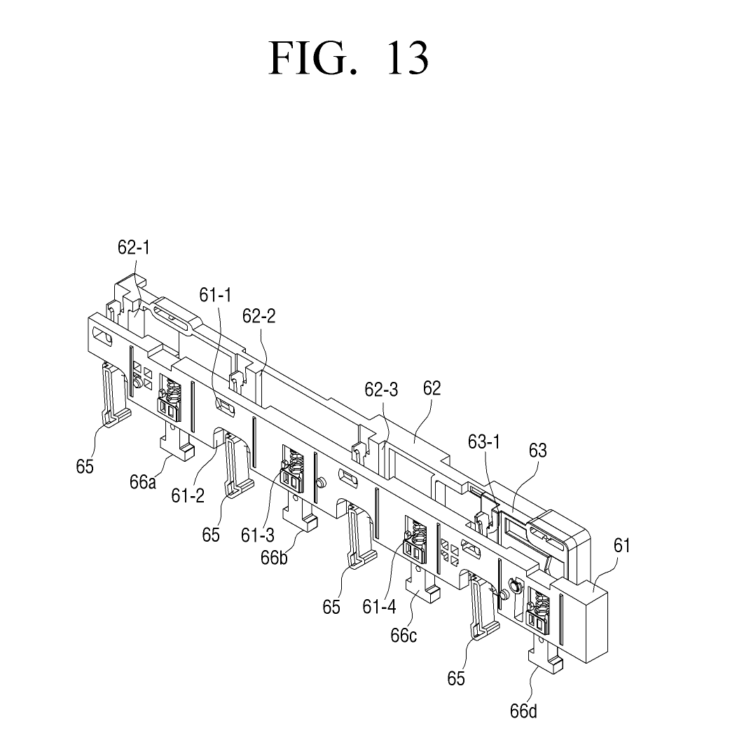

The second supporting member 62 is disposed to face the first supporting member 61 and moves in a vertical direction and a horizontal direction (namely, the lengthwise direction of the first and second supporting members 61 and 62) with respect to the first supporting member 61. As illustrated in FIGS. 13 to 15, three guide portions 62-1, 62-2, and 62-3 are formed on a rear surface of the second supporting member 62 that faces the first supporting member 61. The guide portions 62-1, 62-2, and 62-3 guide up and down movements of the force applying members 65a, 65b, and 65c. Two openings 62-4 and 62-5 are formed on the second supporting member 62 adjacent to the first guide portion 62-1 and the third guide portion 62-3, so that the second and first connecting grooves 61-6 and 61-5 of the first supporting member 61 are exposed to the front surface of the second supporting member 62. The connecting projections of the first lever 56 and the third lever 58 are coupled to the first and second connecting grooves 61-5 and 61-6 of the first supporting member 61 through the openings 62-4 and 62-5.

The third supporting member 63 is disposed to slidably move in the lengthwise direction of the second supporting member 62 on a portion of the second supporting member 62 that faces a portion of the first supporting member 61 on which the fourth fixing member 66d is disposed. In other words, the third supporting member 63 is disposed to linearly move a predetermined distance between the first supporting member 61 and the second supporting member 62. The third supporting member 63 includes two protrusions 63-2 that are inserted in linear movement guide grooves 62-6 of the second supporting member 62. The third supporting member 63 includes a fourth guide portion 63-1 capable of guiding up and down movements of the fourth force applying member 65d. Accordingly, if the third supporting member 63 moves in the lengthwise direction of the second supporting member 62, the fourth force applying member 65d also moves in the lengthwise direction thereof. The distance which the third supporting member 63 can move in the lengthwise direction is equivalent to the gap between the second position, at which the fourth force applying members 65d presses the developing unit 41 of the fourth image forming cartridge 30K so that the developing roller 43 is separated from the image carrier 33, and the third position, at which the fourth force applying members 65 does not press the developing unit 41 so that the developing roller 43 keeps in contact with the image carrier 33.

The second and third supporting members 62 and 63 are moved in the lengthwise direction of the second supporting member 62 by a separation cam 67. Accordingly, opposing portions of the second supporting member 62 and the third supporting member 63 form a cam space in which the separation cam 67 is inserted and can rotate. In particular, the cam space includes a first cam groove 62-7 to receive the separation cam 67 that is formed on a rear surface of the second supporting member 62 that faces the third supporting member 63, and a second cam groove 63-4 to receive the separation cam 67 that is formed on a surface of the third supporting member 63 that faces the second supporting member 62. Accordingly, if the third supporting member 63 is positioned at the rear surface of the second supporting member 62, the first and second cam grooves 62-7 and 63-4 form the cam space.

The separation cam 67 is rotatably disposed in the cam space between the second and third supporting members 62 and 63 and is formed to move the second and third supporting members 62 and 63. The separation cam 67 is rotated by a cam shaft 67-5. A power transmission member may be coupled to an end of the cam shaft 67-5 to receive power from a driving source (not illustrated) of the main body 3.

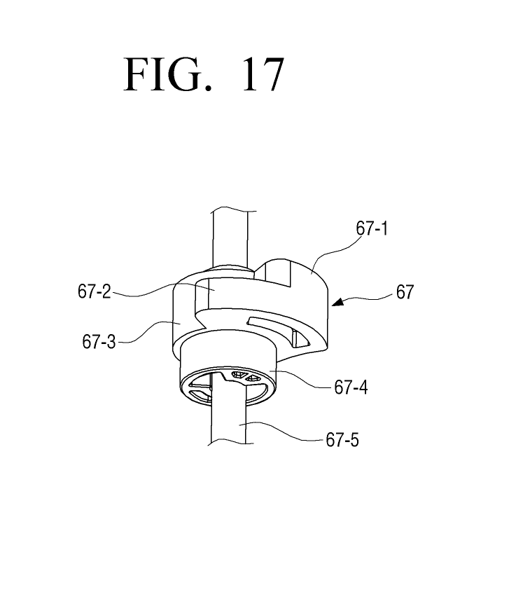

Referring to FIG. 17, the separation cam 67 includes a cam boss 67-4, a first cam portion 67-1 that pushes both the second and third supporting members 62 and 63 in one direction, a second cam portion 67-2 that pushes only the third supporting member 63 in the same direction, and a third cam portion 67-3 that does not push both the second and third supporting members 62 and 63. The first cam portion 67-1 is arc-shaped and has a radial dimension set such that it can press the second and third supporting members 62 and 63 at the same time. The second cam portion 67-2 is arc-shaped and extends from the first cam portion 67-2. The second cam portion 67-2 has a predetermined length and a thickness so that it can press the third supporting member 63 without pressing the second supporting member 62. In other words, the second cam portion 67-2 is formed is a stepped structure formed on the first cam portion 67-1. Accordingly, the second cam portion 67-2 can selectively press the third supporting member 63, without pressing the second supporting member 62. The third cam portion 67-3 is arc-shaped and has a radial dimension set such that is does not press the second and third supporting members 62 and 63.

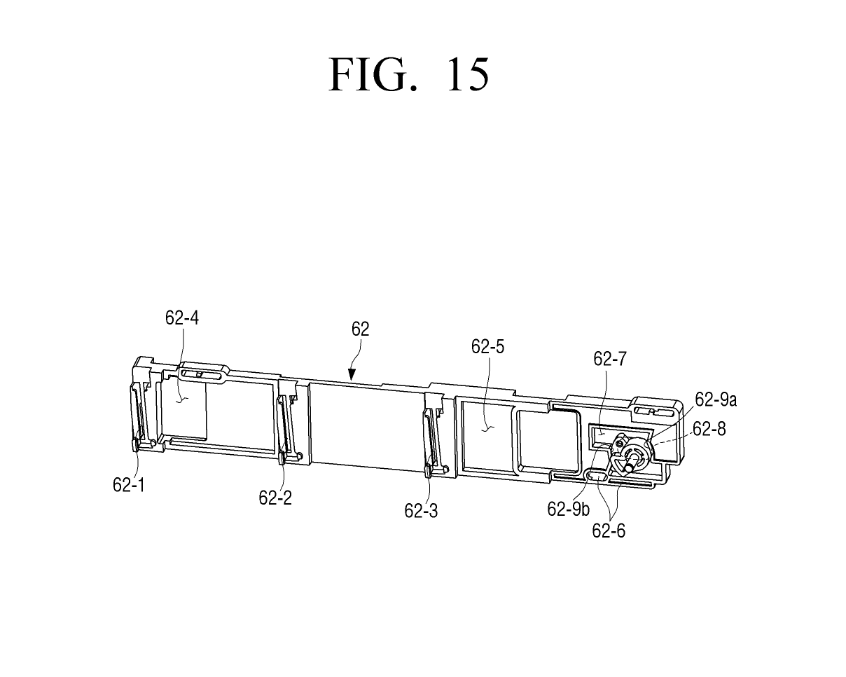

As illustrated in FIG. 15, the second supporting member 62 has a first hole 62-8 formed in the first cam groove 62-7, through which the cam boss 67-4 passes, and first and second cam contacting portions 62-9a and 62-9b that contact the separation cam 67. In particular, the first and second cam contacting portions 62-9a and 62-9b contact the first cam portion 67-1 and the second cam portion 67-2 of the separation cam 67.

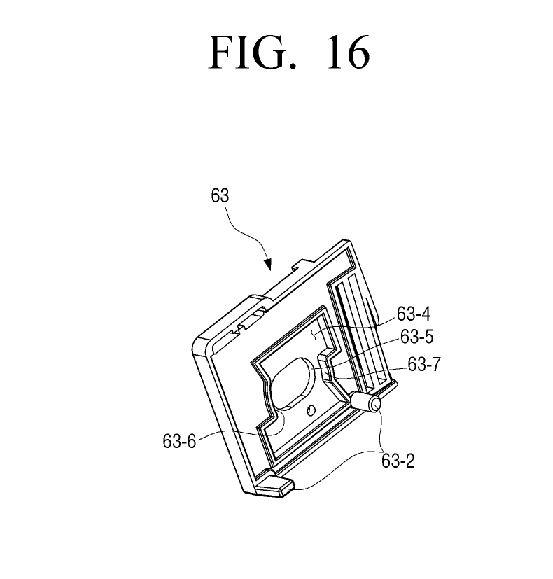

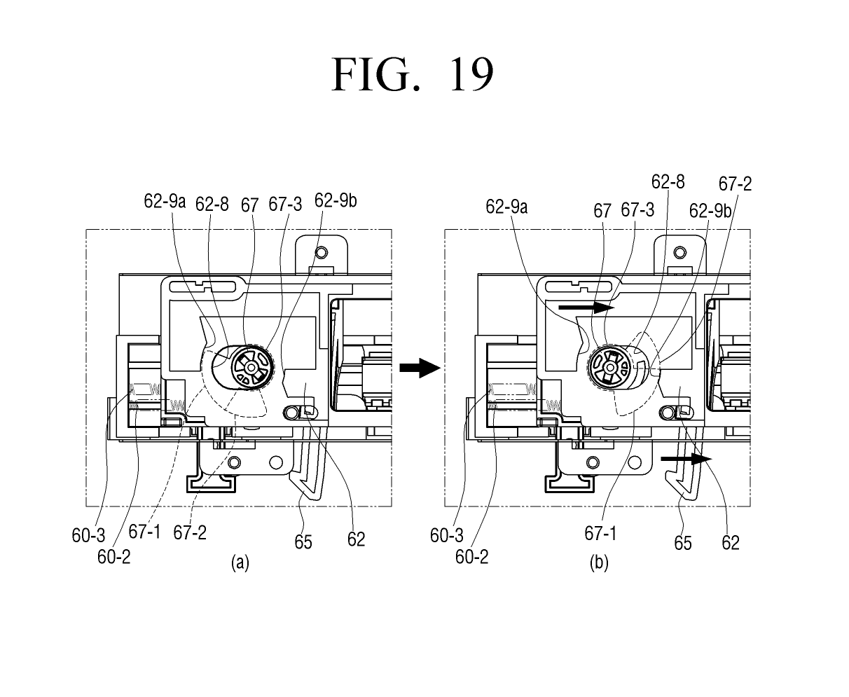

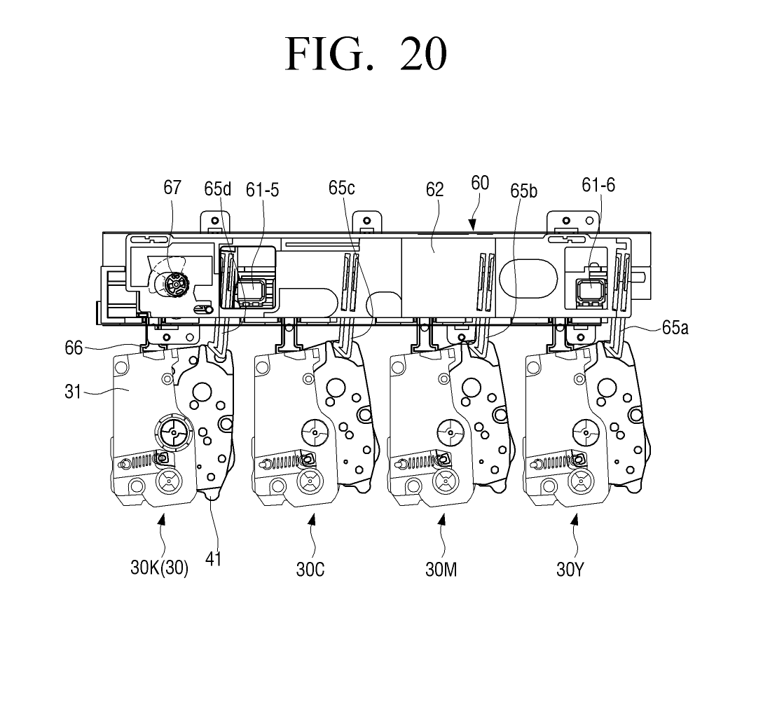

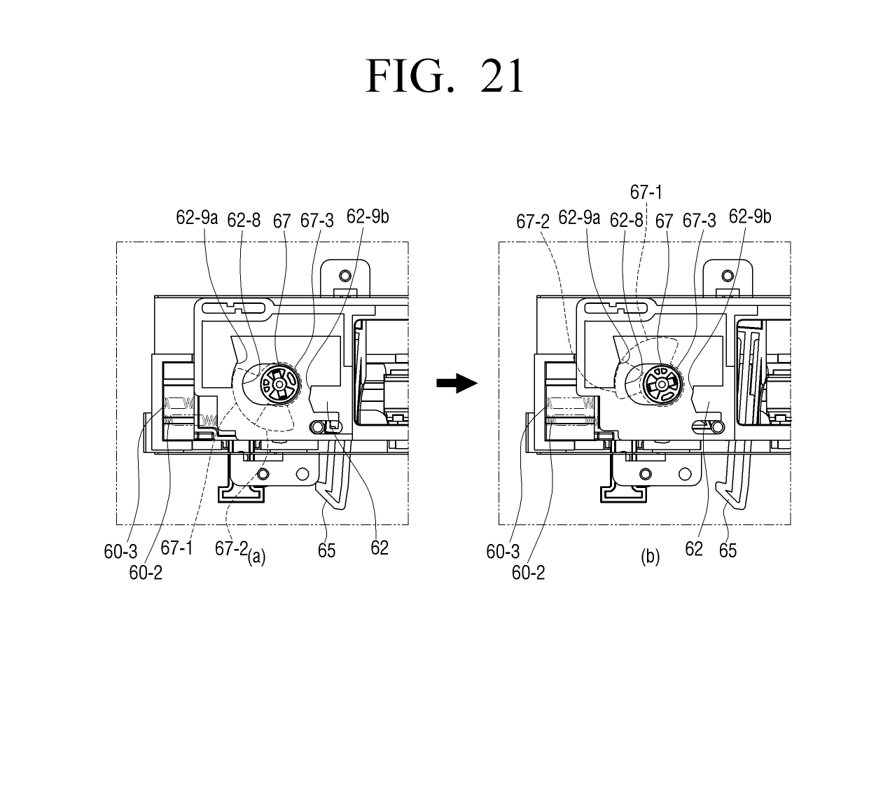

As illustrated in FIG. 16, the second cam groove 63-4 of the third supporting member 63 has a second hole 63-5 through which the cam boss 67-4 passes. The second cam groove 63-4 also includes third and fourth cam contacting portions 63-6 and 63-7 that are in contact with the separation cam 67, that is, the first cam portion 67-1 of the separation cam 67. Accordingly, when the first cam portion 67-1 contacts the first and third cam contacting portions 62-9a and 63-6, as illustrated in FIGS. 19(a) and 21(a), the second and third supporting members 62 and 63 are pushed in the left direction of FIGS. 19(a) and 21(a) by the separation cam 67, so that the force applying members 65 is positioned at the second position to press against the developing unit 41 of the image forming cartridge 30.

The second cam portion 67-2 of the separation cam 67 does not contact the third and fourth cam contacting portions 65-6 and 65-7 of the third supporting member 63, but does selectively contact the first and second cam contacting portions 62-9a and 62-9b of the second supporting member 62, to press the second supporting member 62 in one direction. When the third cam portion 67-3 is positioned to face anyone of the first to fourth cam contacting portions 62-9a, 62-9b, 63-6 and 63-7, the third cam portion 67-3 does not press the second and third supporting members 62 and 63.

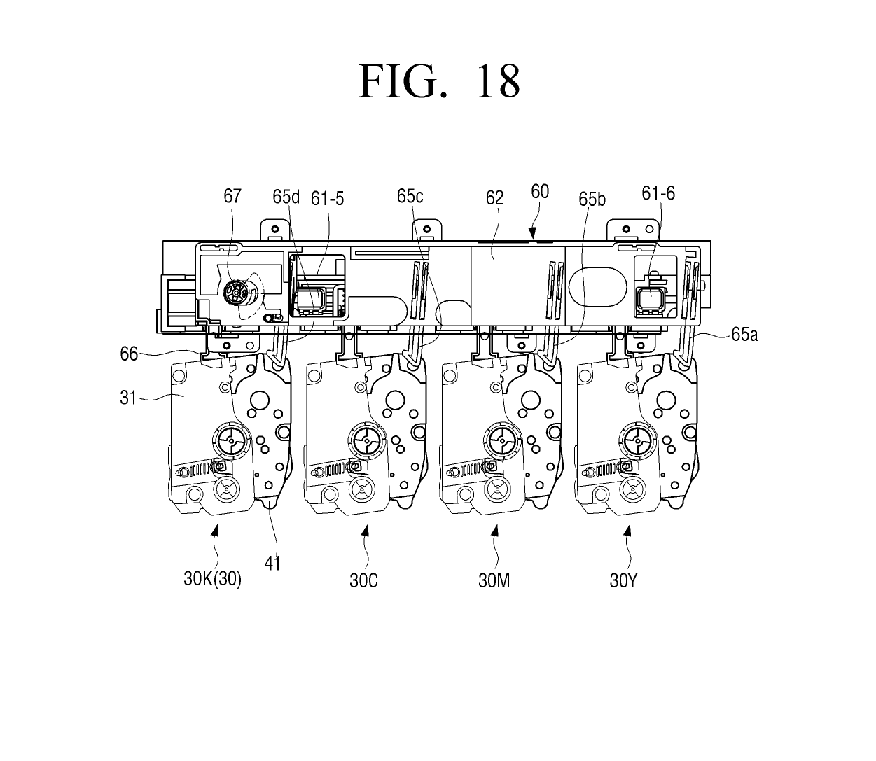

Therefore, as illustrated in FIG. 19(a), after the separation cam 67 rotates approximately 120 degrees in the counterclockwise direction from a state in which the first cam portion 67-1 o contacts the first and third cam contacting portions 62-9a and 63-6, as illustrated in FIG. 19 (b), the third cam portion 67-3 faces the first and third cam contacting portions 62-9a and 63-6, and the first cam portion 67-1 contacts the second and fourth cam contacting portions 62-9b and 63-7. As a result, the second and third supporting members 62 and 63 receive a force from the separation cam 67 and elastic members 60-2 and 60-3 and move in the direction of an arrow shown in FIG. 19 (b). As a result, as illustrated in FIG. 18, the four force applying members 65 move from the second positions to the third positions. Accordingly, the developing roller 43 of each of the four image forming cartridges 30Y, 30M, 30C, and 30K contacts the image carrier 33.

As illustrated in FIG. 19 (b), when the separation cam 67 further rotates in the counterclockwise direction, from a state in which the first cam portion 67-1 contacts the second and fourth cam contacting portions 62-9b and 63-7, and is rotated approximate 240 degrees from an original position, the second cam portion 67-2 contacts the first cam contacting portion 62-9a, and the third cam portion 67-3 faces the second and fourth cam contacting portions 62-9b and 63-7. Accordingly, the second supporting member 62 is moved to the left in FIG. 21(b) by the second cam portion 67-2 and is restored to the same state as shown in FIG. 21 (a). However, the third supporting member 63 is not contacted by the separation cam 67, so as to maintain the original state. Accordingly, the first to third force applying members 65, which are connected to the second supporting member 62, move from the third position to the second position, to contact the developing unit 41 of the image forming cartridge 30. As a result, the image carriers 33 of the image forming cartridges 30 corresponding to the first to third force applying members 65 are separated from the developing rollers 43. However, the fourth force applying member 65, which is connected to the third supporting member 63, is maintained at the third position. Accordingly, the image carrier 33 of the image forming cartridge 30 corresponding to the fourth force applying member 65 remains in contact with the developing roller 43.

Referring to FIGS. 11 to 14, the four force applying members 65 are disposed between the first supporting member 61 and the second supporting member 62. In more detail, the first to the third force applying members 65a, 65b, and 65c, move up and down without regard to the position of the second supporting member 62, due to the first to third guide portions 62-1, 62-2 and 62-3, and move in the lengthwise direction of the first supporting member 61 along with the second supporting member 62. The fourth force applying member 65 moves up and down without regard to the position of the third supporting member 63, due to the fourth guide portion 63-1 formed on the third supporting member 63. The fourth force applying member 65 moves in the lengthwise direction of the second supporting member 62 along with the third supporting member 63.

The four force applying members 65 may have the same shape and include upper portions 65-1 that are inserted into the guide portions 62-1, 62-2, 62-3 and 63-1 of the second and third supporting members 62 and 63. The four force applying members 65 include lower portions 65-2 that project below the second and third supporting members 62 and 63 and press against the developing unit 41 of the image forming cartridge 30. The four force applying members 65 also include upper projections 65-3 that are inserted into the top connecting holes 61-1 of the first supporting member 61. Substantially V-shaped bottom ends 65-4 of the lower portion 65-2 may be referred to as pressing portions that press against the pressed portions 48 of the developing units 41.

Since the upper projections 65-3 of the force applying members 65 are inserted into the top connecting holes 61-1 of the first supporting member 61, when the first supporting member 61 moves up and down, the force applying members 65 also move up and down. Therefore, the four force applying members 65 move between the first position P1, the second position P2, and the third position P3, due to the first to third supporting members 61, 62, and 63 (see FIG. 6), and selectively apply force to the developing units 41 of the image forming cartridges 30. Here, since the first position P1 is spaced apart from and above the developing unit 41, when the force applying members 65 are disposed in the first position P1, the force applying members 65 do not apply a force to (do not contact) the developing units 41. Since the second position P2 is below the first position P1, when the force applying members 65 are disposed in the second position P2, the force applying members 65 apply a force to (move) the developing unit 41 to separate the developing roller 43 from the image carrier 33. The third position P3 is the same height as the second position P2 and is disposed to the side of the developing unit 41, so that the force applying members 65 do not apply a force to (do not contact) the developing units 41. Accordingly, if the force applying members 65 are in the first and third positions P1 and P3, the force applying members 65 do not apply a force to the developing units 41, so that the developing rollers 43 contact the image carrier 33.

The four fixing members 66 are disposed in the fixing member installing portions 61-3 of the first supporting member 61 and are biased by the pressure springs 61-4. When the first supporting member 61 moves down, the fixing member 66 presses against the image carrier unit 31 of the image forming cartridge 30, so that the image carrier unit 31 is fixed and is not moved from a predetermined position. Therefore, if the force applying members 65 are in the first position P1, the fixing members 66 do not apply a force to the image carrier units 31. If the force applying members 65 are in the second position P2 or the third position P3, the fixing members 66 apply a force to the image carrier units 31.

Referring again to FIG. 2, the transfer belt unit 70 includes an intermediate transfer belt 71, a driving roller 72, and a driven roller 73. The intermediate transfer belt 71 repeatedly receives the developer images from the image carriers 33 of the four image forming cartridges 30Y, 30M, 30C, and 30K, and moves the developer images toward the transfer roller 75. The driving roller 72 and the driven roller 73 support and rotate the intermediate transfer belt 71.

At one end of the transfer belt unit 70, the transfer roller 75 is disposed. The transfer roller 75 transfers the developer image formed on the intermediate transfer belt 71 to a printing medium P that is supplied from the feeder unit 10 to between the transfer roller 75 and the intermediate transfer belt 71.

The fusing unit 80 includes a pressing roller 81 and a heating roller 82 that are opposite to each other. The pressing roller 81 and the heating roller 82 apply heat and pressure to fuse the developer image to the printing medium P. A discharging roller 90 discharges the printing medium P including the fused image to the outside of the main body 3 of the image forming apparatus 1.

The control unit 100 forms images that correspond to the received print data on the printing medium by controlling the feeder unit 10, the exposure unit 20, the plurality of image forming cartridges 30, the contact-separating unit 60, the transfer belt unit 70, the transfer roller 75, the fusing unit 80, and the discharging roller 90. If a print command is received, the control unit 100 controls the separation cam 67 of the contact-separating unit 60 to control the positions of the four force applying members 65.

Hereinafter, operation of the image forming apparatus 1 will be described in detail. FIG. 1 illustrates a state of the image forming apparatus 1 before the image forming apparatus is initially used by a user. The four image forming cartridges 30 are mounted in the main body 3 of the image forming apparatus 1 in a manufacturing factory thereof. Since the cover 5 is closed, the four force applying members 65 and the four fixing members 66 of the contact-separating unit 60 respectively press against the developing units 41 and image carrier units 31 of the image forming cartridge 30, due to the connecting unit 50. Accordingly, the image carriers 33 of each of the four image forming cartridges 30 are separated from the corresponding developing rollers 43. After the image forming cartridge 30 is mounted and the cover 5 is closed, the developing rollers 43 of the image forming cartridges 30 are separated from the image carriers 33. Therefore, during distribution, problems caused by the contact between the developing roller 43 and the image carrier 33 may be prevented.

Next, a color printing mode in which the image forming apparatus 1 prints color images will be described. In a preparation mode before the print starts, as illustrated in FIGS. 3 and 8, the force applying members 65 of the contact-separating unit 60 press against the pressed portions 48 of the four image forming cartridges 30Y, 30M, 30C, and 30K. Accordingly, the respective developing unit 41 of each of the image forming cartridges 30Y, 30M, 30C, and 30K are rotated by a predetermined angle around the hinge 40, and a portion of the developing unit 41 below the hinge 40 separates from the image carrier 33, and a portion of the developing unit 41 above the hinge 40 moves closer to the image carrier unit 31. Accordingly, during the preparation mode, the developing rollers 43 are separated from the corresponding image carriers 33, and the elastic members 37 are in a tensioned state.

If a print command is received, the control unit 100 controls the exposure unit 20 to emit light that corresponds to the print data. Thus, electrostatic latent images are formed on the image carriers 33.

Almost at the same time, a high voltage is applied to the charging body 34 to charge the image carrier 33. Also, the control unit 100 controls the separation cam 67 of the contact-separating unit 60 to bring the image carriers 33 into contact with the developing rollers 43.

The control unit 100 controls the contact-separating unit 60 to separate the four force applying members 65a, 65b, 65c and 65d from the pressed portions 48 of the corresponding developing units 41, so that the developing rollers 43 contacts the image carriers 33. In other words, the control unit 100 causes the separation cam 67 to rotate approximately 120 degrees, so that the first cam portion 67-1 contacts the second cam contacting portion 62-9b and the fourth cam contacting portion 63-7, and the third cam portion 67-3 faces the first and third cam contacting portions 62-9a and 63-6 (see FIG. 19 (b)). As a result, the second and third supporting members 62 and 63 are moved a predetermined distance in the lengthwise direction of the contact-separating unit 60, the four force applying members 65 are not press against the pressed portions 48, and the developing units 41 are rotated clockwise around the hinge 40 due to the elastic member 37. After the developing units 41 are rotated, the developing rollers 43 contact the image carriers 33 (see FIG. 5).

Then, electrostatic latent images formed on the image carriers 33 of the four image forming cartridges 30Y, 30M, 30C, and 30K are developed into developer images using developers supplied by the developing rollers 43.

After development of the electrostatic latent image on the image carrier 33 is completed, the control unit 100 causes the separation cam 67 to further rotate so that the separation cam 67 is located at the position shown in FIG. 19 (a). When the separation cam 67 is located at the position of FIG. 19 (a), the first cam portion 67-1 contacts the first and third cam contacting portions 62-9a and 63-6, so that the second and third supporting members 62 and 63 move toward the left side of FIG. 19 (b). As a result, the four force applying members 65 press against the pressed portions 48 of the four image forming cartridges 30Y, 30M, 30C, and 30K. Then, the developing rollers 43 are separated from the image carriers 33.

The developer images are repeatedly transferred to the intermediate transfer belt 71 to form a color image. The color image formed on the intermediate transfer belt 71 is transferred to the printing medium P supplied from the feeder unit 10 by the transfer roller 75.

The color image is fused to the printing medium P by the heat and pressure that is applied by the fusing unit 80. The printing medium P is then discharged to the outside of the main body 3 through the discharging roller 90.

Next, a mono printing mode in which the image forming apparatus 1 prints a black/white image will be described. During the case of the mono printing mode, the control unit 100 rotates the separation cam 67 of the contact-separating unit 60 from the standby state of FIG. 21 (a) by approximately 240 degrees in the counterclockwise direction, as illustrated in FIG. 21(b). When the separation cam 67 rotates from the standby state approximately 120 degrees in the counterclockwise direction, as described above, the second and third supporting members 62 and 63 are moved to the right by the first cam portion 67-1. As a result, the four force applying members 65 are moved from the second position P2 to the third position P3.

After the separation cam 67 continues to rotate by approximately 240 degrees, the second cam portion 67-2 contacts the first cam contacting portions 62-9a. Then, the second supporting member 62 is moved to the left by the separation cam 67. Since the second cam portion 67-2 is not in contact with the third cam contacting portion 63-6, the third supporting member 63 does not receive a force from the separation cam 67. As a result, the third supporting member 63 is not moved to the left by the separation cam 67. Therefore, when the separation cam 67 rotates approximate 240 degrees in the counterclockwise direction, the first to third force applying members 65 are restored from the third position P3 to the second position P2 and press the pressed portions 48 of the three image forming cartridges 30Y, 30M and 30C. As a result, the image carriers 33 and developing rollers 43 of the three image forming cartridges 30Y, 30M, and 30C are separated from each other and do not perform a printing operation. However, the image carrier 33 and the developing roller 43 of the fourth image forming cartridge 30K are in contact with each other and can print black/white images.

If printing is completed, the control unit 100 rotates the separation cam 67 in the counterclockwise direction. Then, the first cam portion 67-1 contacts the first and third cam contacting portions 62-9a and 63-6. Accordingly, the third supporting member 63 also is moved to the left side of FIG. 21 (b) by the first cam portion 67-1 of the separation cam 67. As a result, the pressed portion 48 of the fourth image forming cartridge 30K is pressed by the corresponding force applying member 65, and the developing unit 41 is rotated in the counterclockwise direction around the hinge 40, so that the developing roller 43 is separated from the image carrier 33. After that, the control unit 100 stops the rotation of the developing roller 43 and the image carrier 33.

Next, a case in which a user replaces the image forming cartridge 30 of the image forming apparatus 1 will be described. To replace the image forming cartridge 30, the user opens the cover 5 as illustrated in FIG. 2.

When the cover 5 is opened, the link 51 is moved toward the opening 7 by the cover 5. In other words, when the cover 5 is opened, the connecting pin 5-1 of the cover 5 applies force to the connecting hole 52 of the link 51 so that the link 51 is moved toward the opening 7.

When the link 51 is moved toward the opening 7, the first and second grooves 53-1 and 53-2 of the link 51 also are moved toward the opening 7. When the first and second grooves 53-1 and 53-2 are moved, the first lever 56 and the second lever 57 are moved due to contact with the first and second grooves 53-1 and 53-2. As a result, the first lever 56 and the second lever 57 are rotated in the clockwise direction, and the third lever 58 is rotated in the counterclockwise direction around the third rotation shaft 58-3. As a result, the first supporting member 61 coupled to the first lever 56 and the third lever 58 is moved upward. When the first supporting member 61 is moved upward, the upper projections 65-3 of the four force applying members 65 are moved upward along with the first supporting member 61. As such, the force applying members 65 and fixing members 66 do not interfere with the four image forming cartridges 30. Accordingly, the user can easily separate or mount the image forming cartridge 30 from/into the main body 3.

After a new image forming cartridge 30 is mounted into the main body 3, the user closes the cover 5. When the cover 5 is closed, the link 51 is moved in the right side of FIG. 2 by the connecting pin 5-1 of the cover 5.

When the link 51 is moved in the right side of FIG. 2, the first and second grooves 53-1 and 53-2 of the link 51 also are moved to the right. As a result, the first and second lever 56 and 57 contact the first and second grooves 53-1 and 53-2 and are rotated in the counterclockwise direction, while the third lever 58 is rotated in the clockwise direction around the third rotation shaft 58-3. As a result, the first supporting member 61 contacts the second end 56-2 of the first lever 56, and the second end 58-2 of the third lever 58 is moved downward. When the first supporting member 61 is moved downward, the four force applying members 65 are moved downward along with the first supporting member 61. When the four force applying members 65 move downward, the force applying members 65 press the pressed portions 48 of the four image forming cartridges 30. Accordingly, the developing rollers 43 of the image forming cartridges 30 are separated from the image carriers 33.

As described above, since an image forming apparatus according to an exemplary embodiment of the present disclosure sold in a state that image forming cartridges are mounted in a main body of the image forming apparatus during manufacturing, the packaging volume thereof may be reduced. Therefore, logistical costs also may be decreased.

Further, with an image forming apparatus according to an exemplary embodiment of the present disclosure, since a specific separation member for separating a developing roller from the an image carrier is not required, and a sensor for detecting the separation member is not required, manufacturing costs of the image forming cartridges and the image forming apparatus may be decreased.

Also, with an image forming apparatus according to an exemplary embodiment of the present disclosure, since a user does not need to remove the separation member, user convenience is improved. Further, problems that can be generated when a user does not remove the separation member may be reduced.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus, comprising:
a main body;
image forming cartridges detachably disposed in the main body, each of the image forming cartridges comprising;
an image carrier unit comprising an image carrier;
a developing unit disposed to swing a predetermined amount with respect to the image carrier unit and comprising a developing roller; and
an elastic member to bias the developing roller toward the image carrier;
a cover to selectively cover an opening of the main body;
a contact-separating unit disposed in the main body and configured to selectively separate the developing rollers and corresponding ones of the image carriers; and
a connecting unit to transfer movements of the cover to the contact-separating unit;
wherein when the cover is opened the contact-separating unit separates the developing rollers and the image carriers, and when the cover is closed the elastic members bring the developing rollers into contact with the image carriers.

2. The image forming apparatus of claim 1 further comprising:
a control unit that controls the contact-separating unit according to a print command so that the contact-separating unit separates the developing roller and the image carrier of selected ones of the image forming cartridges.

3. The image forming apparatus of claim 1, wherein the connecting unit comprises:
a link configured to slide along a side wall of the main body and connected to the cover; and
levers disposed on the main body and configured to transfer movements of the link to the contact-separating unit.

4. The image forming apparatus of claim 1, wherein the contact-separating unit comprises:
force applying members to selectively contact the developing units; and
a first supporting member to move each of the force applying members between a first position and a second position.

5. The image forming apparatus of claim 4, wherein when in the first position, the force applying members do not contact the developing units, and when in the second position, force applying members contact corresponding ones of the developing units to separate the developing rollers and image carriers.

6. The image forming apparatus of claim 5, wherein:
when the cover is opened, each force applying member is disposed in the first position; and
when the cover is closed, each force applying member is disposed in the second position.

7. The image forming apparatus of claim 4, wherein the contact-separating unit further comprises fixing members disposed on the first supporting member, each fixing member configured to fix a corresponding one of the image carrier units when a corresponding one of the force applying members is disposed in the second position.

8. The image forming apparatus of claim 1, wherein the contact-separating unit comprises:
force applying members to selectively contact the developing units;
a first supporting member connected to the connecting unit and configured to move each of the force applying members between a first position and a second position; and
a second supporting member to move each of the force applying members between the second position and a third position.

9. The image forming apparatus of claim 8, wherein:
when in the first position, the force applying members do not contact the developing units; and
when in the second position, the force applying members contact the developing units to separate the developing rollers and the image carriers; and
when in the third position, the force applying members do not contact the developing units so that the developing rollers contact the image carriers.

10. The image forming apparatus of claim 9, wherein:
when the cover is opened, the force applying members are disposed in the first position; and
when the cover is closed, the force applying members are disposed in the second position.

11. The image forming apparatus of claim 10, wherein the contact-separating unit further comprises fixing members disposed on the first supporting member and configured to contact the image carrier units when the force applying members are disposed in the second position or the third position.

12. The image forming apparatus of claim 8, further comprising:
a control unit to control the contact-separating unit to separate selected ones of the developing rollers and the corresponding image carriers, according to a print command;
wherein the image forming cartridges comprises first, second, third, and fourth image forming cartridges, and
wherein during a preparation mode, the developing rollers of the first, second, third and fourth image forming cartridges are separated from the corresponding image carriers.

13. The image forming apparatus of claim 12, wherein when in a color printing mode, the control unit controls the contact-separating unit so that the developing rollers of the first, second, third, and fourth image forming cartridges contact the corresponding image carriers.

14. The image forming apparatus of claim 12, wherein when in a mono printing mode, the control unit controls the contact-separating unit to separate the developing rollers of the first, second, and third image forming cartridges from the corresponding image carriers, while allowing the developing roller and the image carrier of the fourth image forming cartridge to remain in contact.

15. The image forming apparatus of claim 14, wherein the contact-separating unit comprises:
a bracket disposed in the main body of the image forming apparatus and configured to slidably support the first and second supporting members;
a third supporting member configured to slide with respect to the second supporting member; and
a separation cam disposed between the second and third supporting members and configured to move the second and third supporting members,
wherein the force applying members comprise a first, a second, and a third force applying members that are configured to move up and down on the second supporting member and that correspond to the first, second, and third image forming cartridges, and a fourth force applying member that is configured to move up and down on the third supporting member and that corresponds to the fourth image forming cartridge.

16. The image forming apparatus of claim 15, wherein the separation cam comprises:
a first cam portion to push the second and third supporting members;
a second cam portion to push the second supporting member; and
a third cam portion that does not push the second and third supporting member.

17. The image forming apparatus of claim 15, wherein:
the second supporting member comprises a first cam groove formed on a surface of the second supporting member that faces the third supporting member;
the third supporting member comprises a second cam groove formed on a surface of the third supporting member that faces the second supporting member; and
the first and second cam grooves form a cam space in which the separation cam is disposed.

18. The image forming apparatus of claim 17, wherein:
the second supporting member comprises first and second cam contacting portions formed in the first cam groove and configured to selectively contact the separation cam; and
the third supporting member comprises third and fourth cam contacting portions formed in the second cam groove and configured to selectively contact the separation cam.

19. The image forming apparatus of claim 15, wherein:
when the separation cam pushes the second and third supporting members in a first direction, the first, second, third, and fourth force applying members move from the second position to the third position; and
when the separation cam pushes the third supporting member in the first direction, the first, second, and third force applying members remain in the second position, and the fourth force applying member moves from the second position to the third position.

20. The image forming apparatus of claim 1, wherein pressed portions are formed on upper surfaces of the developing units and are configured to contact the contact-separating unit.

21. An image forming apparatus comprising:
a main body;
image forming cartridges detachably disposed in the main body, each of the image forming cartridges comprising:
an image carrier;
a developing roller; and
an elastic member to bias the developing roller towards the image carrier; and
a contact-separating unit disposed in the main body and configured to separate the developing roller and the image carrier of selected ones of the image forming cartridges, the image forming cartridges being selected according to a mode of the image forming apparatus.

22. The image forming apparatus of claim 21, wherein:
the contact-separating unit comprises:
force applying members to selectively contact the developing units; and
fixing members biased against the developing units; and
the image forming apparatus further comprises:
a controller to control the contact separating unit to selectively extend the force applying members to separate the image carrier and developing roller of any of the developing units that are not operated during a current operating mode of the image forming apparatus.

23. The image forming apparatus of claim 22, wherein the contact-separating unit further comprises:
a cam member to selectively extend the force applying members.
